(19) United States
(12) Patent Application Publication
(10) Pub. No.: US 2016/0228966 A1
(43) Pub. Date: Aug. 11, 2016

(54) METHOD FOR PRODUCING A METAL-CERAMIC SOLDERED CONNECTION

(71) Applicant: KISTLER HOLDING AG, Winterthur (CH)

(72) Inventors: GIOVANNI MASTROGIACOMO, ZURICH (CH); HANS-BEAT MÄRKI, KOLLBRUNN (CH)

(73) Assignee: Kristler Holding AG, Winterhur (CH)

(21) Appl. No.: 15/025,339

(22) PCT Filed: Oct. 6, 2014
(86) PCT No.: PCT/CH2014/000144

§ 371 Date: Mar. 28, 2016

(30) Foreign Application Priority Data
Oct. 8, 2013 (CH) 1717/13

(51) Int. Cl. B23K 1/19; B23K 35/30

(52) U.S. Cl. CPC B23K 1/19; B23K 35/3006; B23K 35/3013; B23K 1/008

(57) ABSTRACT

A method for producing a material-bonding metal-ceramic soldered connection of an uncoated ceramic body to a metal part uses a metallic solder and begins by choosing the metal part with a 50% fraction of an oxygen-affine element; choosing the ceramic body with at least 80% aluminum oxide, zirconium oxide, silicon oxide or an alloy thereof; choosing an inactive, eutectic or near-eutectic solder; and forming a structure with the ceramic body and the metal part with an intermediate space between the their opposing surfaces. The solder is introduced into the intermediate space or the vicinity thereof. The structure is heated in a vacuum at a soldering temperature (T) greater than the liquidus temperature (TL) of the solder for a soldering period. The connection is applied between a ceramic bushing and a high-temperature sensor.

### CROSS-REFERENCE TO RELATED APPLICATIONS

This application claims priority to International Application Serial No. PCT/CH2014/000144, filed Oct. 6, 2014, which claims priority to Swiss Application No. 1717/13, filed Oct. 8, 2013. International Application Serial No. PCT/CH2014/000144 is hereby incorporated herein in its entirety for all purposes by this reference.

### FIELD OF THE INVENTION

The present invention describes a method for producing a materially-bonded metal/ceramic solder connection of an uncoated ceramic body to a metal part with coefficients of thermal expansion of the ceramic body and the metal part, which are tuned to one another, while using a metallic solder, and also a metal/ceramic solder connection with an intermediate space, which is filled at least to some extent by a solder, between a surface of an uncoated ceramic body and a surface of a metal part and also a connecting device for the electrically and thermally insulated laying of electrical supply lines into a space at high temperatures.

### BACKGROUND

In a few technical fields, ceramic bodies are connected to metal parts by means of soldering methods. Metal/ceramic solder connections of this type are of particular importance primarily in the field of miniaturised components, such as plug ducts for sensors for various uses.

The work steps required for producing a metal/ceramic solder connection according to the prior art, by way of example between a ceramic body 1 and a metal part—here realised as a steel part—are illustrated in FIG. 1a, wherein a ceramic duct 6 of a high-temperature sensor is created.

In a first step I schematically represented in FIG. 1a, the provided connecting point must be applied in a layer by means of an Mo/Mn paste, for example by means of spraying or spreading and subsequent stoning of the paste at approx. 1400° C. under a reducing atmosphere, so that a metallised ceramic results.

In a further step II schematically represented in FIG. 1a, galvanic nick& plating of the metallisation also takes place, so that the liquid AgCu solder then wets the nickel-plated ceramic surface of the ceramic body 1 just as well as the metal part to be connected. Subsequently to the steps preparing the ceramic body 1, the metal part, here a collar and/or a contact carrier, can be positioned at or on the ceramic body 1 in a mounting step III schematically represented in FIG. 1a, and the solder can be applied. After positioning the parts relatively to one another, the same are connected to one another at high temperature at the joining location by means of a soldering process step IV schematically represented in FIG. 1a. The ceramic surface must be coated according to the prior art, which here takes place by means of the steps I and II.

A solder connection according to the methods of the prior art after passing through steps I to IV schematically represented in FIG. 1 a is shown in the sectional view in FIG. 1b, wherein a metal part 2′, 3′ is connected in a materially-bonded manner to the ceramic body 1 by means of solder 4. The coating 11 of the ceramic surface of the ceramic body 1 in the form of a nickel-plated metal coating can clearly be seen. The simply commercially available solder 4 that is used connects the metal part 2′, 3′ and the coated ceramic surface to one another in a materially-bonded manner.

The coating of the ceramic body is absolutely necessary and very complicated. Here, the nickel plating is additionally carried out in step II schematically represented in FIG. 1a, in order to improve the wettability of the metallised ceramic.

Due to the application of a sufficiently thick additional metallisation and/or additional protective layers, further processing is difficult for small dimensions of the ceramic body and metal parts and can only be carried out with relatively large tolerances.

In order to simplify the production of a solder connection between a ceramic surface and a metal part, it was suggested in DE 19734211 C2 to mechanically coat the ceramic surface with a reactive component and subsequently to solder the same to the metal part. The coating can for example take place by rubbing a titanium-containing sheet or a rod on the ceramic surface. It is not clear whether the simple coating method described here functions sufficiently well. However, an oxidation starts rapidly if a protective layer is not applied, for which reason, the solder connection must be created as immediately as possible after the production of the coating.

A connection method by means of a soldering process is known from EP356678, which delivers good connection results, wherein a soldering process takes place after coating and nickel-plating and subsequent mounting.

It is shown in U.S. Pat. No. 4,591,535 that when an active solder 4′ with oxygen-affinitive elements is used, a coating-free or non-metallised ceramic body could be connected to a metal part made from steel. In this case, it was possible to dispense with a preceding metallisation and nickel-plating of the ceramic body, so that the resulting method according to FIG. 2 comprises just one mounting step III and the soldering process IV using the active solder 4′. In this case, the soldering process IV was carried out at the temperature range known for active solders 4′. The materially-bonded connection takes place by means of active solder: The oxygen-affinitive element, for example titanium, is already alloyed in the solder. A connection by means of active solder requires a higher melting temperature compared to the use of non-active solders and particular attention in designing the components to be joined, because active solders do not flow like conventional solders and the capillary effect cannot be used. A ceramic/metal connection achieved by means of active solder 4′ shows a structure wherein ceramic body, active solder and metal part form layers that can be clearly differentiated from one another.

In the case of a sensor according to DE 202010016357 U1, a sensor element is arranged in a ceramic body, which can be contacted by means of a metallic contact, which is produced by means of a solder connection. The solder used is an active solder.

In the case of a pressure sensor according to DE 102010003145 A1, a measuring membrane is connected in a pressure-tight manner by means of active hard solder of a Zr/Ni/Ti alloy. A second active hard solder connects a primary signal path from a transducer of the measuring membrane to measuring electronics.

Active solders are not simply commercially available and for the most part must be procured from specialist suppliers for comparatively high costs. Because active solders have a higher melting point or higher processing temperatures compared to non-active solders, thermal stresses in the ceramic body increase, which results in a stronger susceptibility to cracking. This is because the coefficients of thermal expansion of metal and ceramic differ. if the two components are connected to one another at a high temperature, stresses inevitably form after they have reached room temperature again. In order to reach the high solder temperatures of the active solders, a high energy consumption is also inevitably necessary.

Because the capillary gap between ceramic surface and metal-part surface made from steel is not filled with active solder completely when using active solders without coating the ceramic body, the solder connections have the shape of fillet seams, which is disadvantageous for ducts, as described here, for example. Active solders are unsuitable for capillary soldered connections, because the active component can already be consumed before a complete penetration of the solder into the capillary and as a result, the gap between ceramic body and metal part cannot be completely connected in a materially-bonded manner. To produce a metal/ceramic solder connection according to the prior art, in which a preceding metallisation and nickel plating is carried out, a capillary solder gap width of 0.05 mm is generally to be assumed, because the layer thickness can vary.

### SUMMARY OF THE INVENTION

It is an object of the present invention to create a method for producing a materially-bonded metal/ceramic solder connection of an uncoated ceramic body to a metal part with mutually tuned coefficients of thermal expansion of the ceramic body and the metal part, wherein the use of active solders, which are difficult to procure and costly, and also special preceding coating of the ceramic body should be dispensed with. The achievement of a metal/ceramic solder connection with as little outlay as possible for low costs is also desirable. In addition, the connection should satisfy high demands and in particular not be brittle or fragile.

Using the method according to the invention, the capillary solder flow can be controlled similarly well as in the case of a preceding metallisation, which results in a high mechanical loadability of the metal/ceramic connections to be produced, wherein the metal/ceramic connections also withstand relatively high shear loads as well in particular.

A partial object of the invention consists in creating a ceramic duct for at least one high-temperature sensor, suitable for a use temperature greater than 200° C., with a metal/ceramic connection of this type.

The invention furthermore relates to a metal/ceramic solder connection between a ceramic body and a metal part produced according to the method according to the invention.

An object is achieved by means of a method, which is described by hereinafter. The following steps are executed according to the invention: A metal part with a proportion of at least 50% of an oxygen-affinitive element and a ceramic body, at least 80% of which consists of aluminium oxide, zirconium oxide, silicon oxide or a mixture thereof, are chosen. In addition, an inactive, eutectic or virtually eutectic solder is provided. Subsequently, a structure is built with the ceramic body and the metal part, wherein intermediate space is disposed between their opposing surfaces. Ceramic body and metal part can also bear against one another, the resultant intermediate space is completely satisfactory. In this case, the solder is brought into the vicinity of or into the intermediate space. Subsequently, the structure is put into an oven and a vacuum or an oxygen-free protective-gas atmosphere is set up around the structure with the solder, Then the oven is brought to a solder temperature T of greater than the liquidus temperature TL of the solder and preferably at most 60° C. above that (TL<T≦TL+60° C.). This solder temperature T is then maintained in the oven for a solder duration Δt until the solder forms a mixed-phase region M together with a portion of dissolved metal part, which completely fills and wets the intermediate space, Subsequently, the structure is left to cool to ambient temperature again.

An advantage of this method according to the invention is the fact that a lower solder temperature can be set up, because the inactive solder does not contain any titanium. The lower solder temperature means that the finished part has fewer stresses after it is cooled to room temperature.

In addition, it has been shown that titanium-containing solders for the most part contain too much titanium, as a result of which the connections become brittle. In the present case, the connection takes exactly as much titanium or other oxygen-affinitive elements from the metal as it requires for the connection and not more. As a result, a high-quality connection results.

In addition, a capillary solder connection is possible using the described method, which is not possible using a titanium-containing solder, such as for example in U.S. Pat. No. 7,771,838.

In particular, the connection is produced under oxygen-free protective gas or vacuum, so that no oxidation takes place. In conventional methods, for example in the case of a copper-containing metal, an oxide layer is formed, which is used as solder during direct bonding, as for example in EP 2263820.

### BRIEF DESCRIPTION OF THE DRAWINGS

A preferred exemplary embodiment of the subject of the invention is described in the following in connection with the attached drawings.

FIG. 1a schematically shows a method for producing a metal/ceramic solder connection, by means of which an at least partially metallised ceramic body is fastened on a metal part by means of commercially available solder according to the prior art, whilst

FIG. 1b shows a microscope image of a sectional view of a met ceramic solder connection, produced using the method according to FIG. 1a,

FIG. 2 schematically shows a soldering process according to the prior art, using an active solder, wherein a metallisation has been dispensed with.

FIG. 3a shows the schema of the method according to the method invention for producing a metal/ceramic solder connection, whilst

FIG. 3b shows a microscope image of a section of a metal/ceramic solder connection, produced using the method according to the invention.

FIG. 4a shows a sectional view of the arrangement of a ceramic body relatively to a metal part before the melting of the solder, whilst

FIG. 4b shows a sectional view of the ceramic body and the metal part after the soldering process, wherein the result is a ceramic duct of a high-temperature sensor.

FIGS. 5a, 5b show the ceramic duct according to FIGS. 4 with a disc, which is additionally soldered in, before and after the soldering process in a sectional view.

FIG. 6 shows a high-temperature sensor with installed ceramic duct.

### DESCRIPTION OF EXEMPLARY EMBODIMENTS OF THE INVENTION

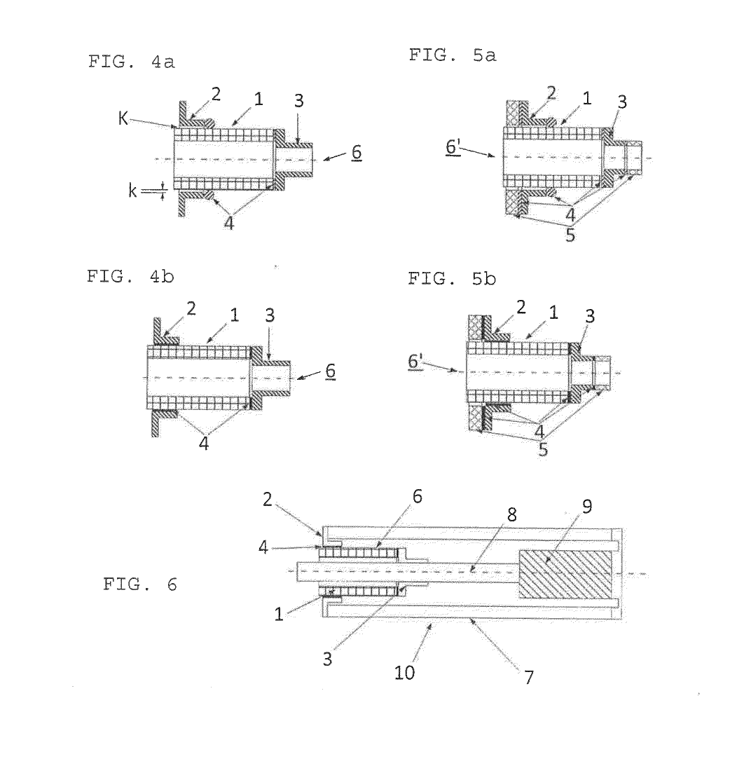

The method according to the invention for producing a materially-bonded metal/ceramic solder connection, which is described below, is described on the basis of a ceramic duct 6, as illustrated in FIGS. 4-6, which is created by means of a materially-bonded connection of an uncoated ceramic body 1 to a metal part 2, 3. The coefficient of thermal expansion of the ceramic body 1 and the metal part 2, 3 are chosen to be tuned to one another, that is to say similar to one another. At least 80% of the ceramic body 1 should consist of aluminium dioxide (sapphire), silicon dioxide or a mixture thereof. According to the invention, it is uncoated and correspondingly has no metallised and nickel-plated ceramic-body surface. This saves a work step in the method according to the invention compared to similar methods according to the prior art.

Conventional and relatively inexpensive metallic non-active solders are used as solder 4. It is important that the solders 4 used are eutectic or near eutectic. Solders in the form of silver- or gold-based solders, for example AgCu, AgCuPd or AuNi or the like are preferred in particular. The solidus temperature and the liquidus temperature TL should either be equal, which means the solder 4 is eutectic, or both temperatures should differ by less than 5 K, which is termed near eutectic. Furthermore, the solder 4 used should preferably be low-melting solders 4 with liquidus temperatures TL<1000° C., so that the thermal loading of the components remains low during the soldering process IV. They can be present in the form of a film or a wire in particular. At a low production temperature, the risk of stress between metal part 2, 3 and ceramic body 1 is reduced, because the same have coefficients of thermal expansion which, even if they are also similar, are nonetheless unequal.

The metal parts 2, 3 to be connected must have a proportion of 50% at least of an oxygen-affinitive element, so that the same can be connected in a materially-bonded manner to the ceramic body using the method presented here. Preferably, the metal parts 2, 3 are chosen from titanium, hafnium or zirconium or alloys of these elements.

In a mounting step III as schematically represented in FIG. 3a, the metal part 2, 3 to be connected is positioned at or on the ceramic-body surface to of the uncoated ceramic body 1 and held aligned with respect to one another, wherein an intermediate space or a capillary gap between the surface of the ceramic body 1 and a surface of the metal part 2, 3 facing the ceramic body 1 is formed, A retaining device can be used to this end. Subsequently or simultaneously to the positioning with respect to one another, the solder 4 is brought into the region of or into the intermediate spaces, which can be configured as capillary gaps, and thus brought into contact with the ceramic body 2 and the metal part 2, 3.

The solder 4 can in this case have the shape of wire-shaped solder 4 or a solder film 4. The solder film 4 is preferably laid in the intermediate space and can also fill the same.

After transporting the structure comprising the ceramic body 1, the metal part 2, 3 and also the solder 4, the soldering process IV takes place as schematically represented in FIG. 3a in an oven at a solder temperature T under vacuum or in a protective-gas atmosphere. It is important that the structure is placed in an oxygen-free environment, so that no oxidation can take place. Because the method is sensitive to the set solder temperature T, to which the structure is brought in the oven, it must be possible to set this precisely and keep it constant for a soldering duration Δt.

Experiments have shown that even a solder temperature T, which is a few degrees above 780° C., for example 3-5° C. higher, when using a silver-based solder 4 for a soldering duration At of five to ten minutes leads to good results. It is important however, that the solder temperature T is chosen to be greater than the liquidus temperature TL of the chosen solder 4 and less than or equal to the liquidus temperature plus 60° C. of the chosen solder 4 during the soldering duration Δt. Thus, the solder temperature T must be chosen to be between TL<T≦TL+60° C.

Subsequently to the soldering process, the mutually connected components, namely the ceramic body 1 and the metal part 2, 3, cool down, as a result of which a materially-bonded connection is created in the intermediate space between these components.

Using the previously known prior art, the creation of a metal/ceramic solder connection between an uncoated ceramic body and a metal part 2, 3 was only possible using special active solders. According to the invention, no active solder is used in the method described here, rather a conventional non-active solder 4 is used. It is decisive on the one hand that a metal part 2, 3 is used, which has a proportion of 50% of an oxygen-affinitive element, and the setting of the solder temperature T is in a small defined temperature range between TL<T≦TL+60° C.

In the soldering process IV as schematically represented in FIG. 3a, the solder 4 melts and wets the metal surface of the metal part 2, 3. In addition, a portion of the metal part 2, 3 is dissolved and constituents of the oxygen-affinitive element of the metal part 2, 3 are transferred to the solder 4 and are dissolved therein. A mixed phase region M is created, in which the non-active solder 4 is mixed with the oxygen-affinitive element from the metal part 2, 3. By using metal parts 2, 3 with a proportion of at least 50% of an oxygen-affinitive element, a steady delivery of an active component to the non-active solder 4 takes place during the soldering process IV, specifically in the precise quantity of the requirement, because the oxygen-affinitive elements are available in an unlimited quantity. Thus, here, during the soldering process IV, a non-active solder 4 is activated by the release of the oxygen-affinitive element from the metal part 2, 3. The ceramic body 1 and the metal part 2, 3 are correspondingly connected to one another in a materially-bonded manner by the solder 4 and the mixed-phase region M. In particular, during the soldering process, a thickness of the metal part 2, 3 of greater than or equal to 3 pm normal to the surface of the metal part 2, 3, which faces the intermediate space or the capillary solder gap K, is completely dissolved and fills the intermediate space or capillary solder gap K together with the solder 4.

As can be seen in the sectional view according to FIG. 3b, a constituent of the metal part 2, 3 during the soldering process IV merges into the solder 4, so that a mixed-phase region M made from solder 4 and metal part mass is formed. The melted solder 4 accumulates during the soldering process with oxygen-affinitive material of the metal parts 2, 3, wherein the mixed-phase region M made from metal and solder 4 is formed between metal part 2, 3 and the uncoated ceramic body 1, fills the intermediate space and connects the two parts to one another in a materially-bonded manner.

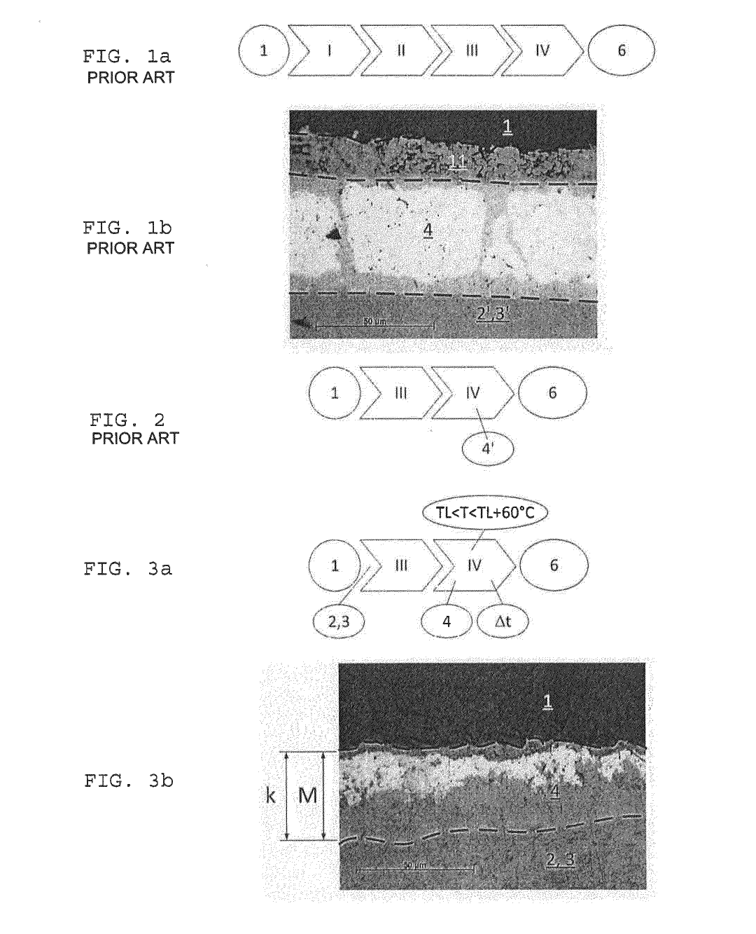

A part of the mass of the metal part 2, 3 in the surface is correspondingly consumed during the soldering process IV and the metal part 2, 3 is correspondingly corroded. This can be seen in FIG. 3b, because this boundary line, here illustrated dashed, does not run in a straight line. Microscope images of metal/ceramic solder connection according to the prior art, depicted in FIG. 1b, by contrast show boundary surfaces with clearly discernible and sharply and linearly delimited boundary surfaces of the metal parts 2′, 3′ and the ceramic body. Because FIG. 3b is not depicted in colour, the boundary between the metal part 2, 3 and the solder 4 cannot be recognised in this black/white figure. It has therefore been highlighted using the dashed line. The boundary line in FIG. 3b is therefore not linear, because a part of the surface has mixed with the solder.

Because the solder temperature T lies clearly below the melting temperature of the ceramic body 1, the surface of the ceramic body 1 does not change. The solder 4 of the mixed-phase region M and melted metal fill the entire intermediate space or capillary solder gap K between metal-part surface and ceramic body surface. In the mixed-phase region M, a concentration gradient is set, wherein a high concentration of oxygen-affinitive elements is present in the vicinity of the metal parts 2, 3, which concentration decreases with increasing distance from the metal parts 2, 3. In this case, the thickness of the mixed-phase region M corresponds to the intermediate space or the capillary solder gap width k.

Experiments have shown that portions of the surface of the metal part 2, 3 in the region of a thickness of greater than 30 pm normal to the surface of the metal part 2, 3, which faces the capillary solder gap K, are completely dissolved. This dissolved quantity of material of the metal part 2, 3 fills the intermediate space or the capillary solder gap K with the solder 4 during the soldering process IV.

In FIGS. 4 and 5, various ducts 6, 6′ with an uncoated ceramic body 1 and at least one metal part 2, 3 are shown in a sectional view after the mounting step III (FIG. 3a) in FIGS. 4a and 5a and after the soldering process IV (FIG. 3a) in FIGS. 4b and 5b.

In FIG. 4a, a duct 6 for a high-temperature sensor is shown, which is not illustrated and consists of the ceramic body 1, a metallic collar 2 and a metallic contact support 3, here formed from a grade 5 titanium material. Ceramic body 1 and the metal parts 2, 3 are mounted aligned relatively to one another, wherein the metal parts 2, 3 are fastened on the ceramic body 1 such that they are electrically insulated from one another. A capillary solder gap K with fixed capillary solder gap width k is formed between the surface sections of the ceramic body 1 and the oppositely arranged metal part 2. The contact support 3 is aligned in such a manner relatively to the ceramic body 1 that an intermediate space is formed between a surface of the contact support 3 and the surface of the end face of the ceramic body 1.

An AgCu solder 4 is used as solder, which is present in the form of wire solder, solder film or paste and is placed in the vicinity of the capillary solder gap K between collar 2 and ceramic body 1. Further solder 4 is arranged in the intermediate space between the end face of the ceramic body 1 and the surface of the contact support 3 in film form. The AgCu solder 4 comprises a proportion of 72% by weight silver and 28% by weight copper. Because uncoated ceramic bodies 1 are used, defined capillary solder gap widths k of less than 0.03 mm can be achieved simply and reproducibly. The metal part 2, 3 can also be arranged contacting the ceramic body 1, so that the intermediate space only comes about due to the unevennesses of the two surfaces. This is enough so that the solder 4 flows due to the capillary action between the surfaces of metal part 2, 3 and ceramic body 1 and produces the desired connection, Metal part 2, 3 and ceramic body 1 can accordingly be laid flat on top of one another, for example.

After the mounting step III (FIG. 3a), including arranging the solder 4, is completed, the structure is vacuumised in a vacuum oven and the soldering process IV (FIG. 3a) is carried out at a solder temperature of a little, for example 3-5° C. greater than 780° C. for five minutes. The result is shown in FIG. 4b. The solder 4 has filled the capillary solder gap K completely during the soldering process IV. Constituents of the titanium of the metal parts 2, 3 have merged into the solder 4 and have formed the mixed-phase region M with an extent greater than zero. It has been shown in experiments that the solder connection is dense and the ceramic body 1 remains free from cracks. The intermediate space between contact support 3 and ceramic body 1 is also filled completely, wherein a materially-bonded connection is also achieved here.

As shown in FIGS. 5a and 5b, further add-on parts, here two discs 5 made from steel of a steel grade 1.4301 can also be soldered to the metal parts 2, 3 in the same soldering process IV (FIG. 3a). The AgCu solder 4 was also used here and brought into the vicinity of the capillary solder gap K or into the intermediate space between ceramic body 1 and the contact support 3 and between contact support 3 and disc 5. The soldering process was carried out with the same solder temperature T for the same soldering duration Δt. Experiments have shown dense and crack-free connections after the soldering process IV (FIG. 3a).

A high-temperature sensor 10 is shown in FIG. 6, which comprises a measuring element 9 mounted in a housing 7. A conductor 8 is electrically insulated from a housing 7 by means of the duct 6, which is also termed ceramic duct. Supply lines can be guided through the uncoated ceramic body 1, which is free from metallising layers and is here configured as Al₂O₃, crossing the housing 7 up to a measuring element 9. The collar 2 with at least one portion of 50% of an oxygen-affinitive element, here of grade 5 titanium, is connected to the ceramic body 1 in a materially-bonded manner by means of a metal/ceramic solder connection and solder 4. The housing 7 of the high-temperature sensor 10 described here is fastened on the collar 2. The contact support 3 is connected on an end face of the ceramic body 1 by means of a metal/ceramic connection. A high-temperature sensor 10 of this type can be arranged in a combustion chamber of an internal combustion engine for example, wherein an electrical decoupling of the supply lines of the measuring element 9 from the combustion chamber and from the housing 7 of the high-temperature sensor 10 is achieved. Thus, a loss-free forwarding of the charges detected at the measuring element 9 can be achieved. Such high temperatures 10 are used in the temperature range above 100° C. to 350° C. in particular.

Because of the unnecessary preceding metallisation, the ceramic chosen for the ceramic body 1 can be free from any glass phases, Purer ceramics can be used as a result, which are characterised by higher electrical insulation. The ceramic body can be chosen such that it has a glass-phase portion of 0 to 6% by weight.

In addition, uncoated ducts 6 comprising ceramic bodies 1 can be produced with narrower mass and shape tolerances than is possible using methods of the prior art.

Metal/ceramic connection and connections of this type having ducts, which were produced using gold-based solders 4, are also helium-tight at application temperatures above 350° C., which is desired in various fields of use.

When non-active solders 4 are used, lower solder temperatures T can be set than when active solders are used. This is advantageous, because the stress loads arising during the soldering process IV (FIG. 3a) are correspondingly reduced.

### REFERENCE LIST

1 Ceramic body, uncoated
2 Metal part/collar (at least 50% oxygen-affinitive element)
2′ Metal part
3 Metal part/contact support (at least 50% oxygen-affinitive element)
3′ Metal part
4 Solder (silver- or gold-based) eutectic/near eutectic, non-active
4′ Active solder
5 Disc (made from steel or a nickel-based alloy)
6 Duct/ceramic duct
6′ Duct/ceramic duct
7 Housing
8 Conductor
9 Measuring element
10 High-temperature sensor
11 Metallisation
I Coating step +stoving
II Nickel plating
III Mounting step
IV Soldering process
Δt Solder duration
LT Liquidus temperature of the solder
M Mixed-phase region
K Capillary solder gap
k Capillary solder gap width

1. A method for producing a materially-bonded metal/ceramic solder connection of an uncoated ceramic body to a metal part with coefficients of thermal expansion of the ceramic body and the metal part, which are tuned to one another, while using a metallic solder, the method comprising the steps:
choosing the metal part having a proportion of 50% of an oxygen-affinitive element,
choosing the ceramic body having at least 80% of which consists of aluminium oxide, zirconium oxide, silicon oxide or a mixture thereof;
choosing a solder that is either an inactive solder, or a solder that is eutectic or a solder that is a near eutectic solder;
formation of a structure with opposing surfaces of the ceramic body and the metal part, wherein the opposing surfaces thereof form an intermediate space with respect to one another, wherein the solder is brought into the vicinity of or into the intermediate space;
putting the structure into an oven;
application of a vacuum or an oxygen-free protective gas atmosphere around the structure with the solder;
heating the oven to a solder temperature greater than the liquidus temperature (TL) of the solder;
maintenance of the solder temperature in the oven for a solder duration until the solder, forming a mixed-phase region (M) together with a portion of dissolved metal part, completely fills and wets the intermediate space.

2. The method according to claim 1, wherein the oven is heated at most to a solder temperature of 60° C. above the liquidus temperature of the solder.

3. The method according to claim 1, wherein the metal part comprises titanium, hafnium or zirconium or an alloy of these elements as oxygen-affinitive element.

4. The method according to claim 1, wherein the solder duration is between five and ten minutes.

5. The method according to claim 1, wherein low-melting non-active solders with a liquidus temperature lower than or equal to 1000° C. are used.

6. The method according to claim 5, wherein a silver- or gold-based solder is used.

7. The method according to claim 1, wherein the solder is present in the form of wire solder, solder film or paste.

8. The method according to claim wherein the intermediate space forms a capillary solder gap.

9. The method according to claim 1, wherein the metal part and the ceramic body are positioned in such a manner that the size of the intermediate space is not greater than 0.03 mm.

10. The method according to claim 1, wherein the ceramic body has a glass-phase portion of 0 to 6% by weight.

11. A materially-bonded metal/ceramic solder connection with an intermediate space, which is filled at least to some extent by a solder, between a surface of an uncoated ceramic body, at least 80% of which consists of aluminium oxide, zirconium oxide, silicon oxide or a mixture thereof, and a surface of a metal part, wherein the metal part comprises a proportion of at least 50% of an oxygen-affinitive element, and in that at least 80% of the ceramic body consists of aluminium oxide, zirconium oxide, silicon oxide or a mixture thereof, and in that the solder is an eutectic or near eutectic, non-active solder, and wherein the intermediate space is completely filled by a composition, which forms a mixed phase region and is an alloy made up of a portion of dissolved metal part and the solder, wherein the transition from mixed-phase region to metal part is configured to be gradual.

12. The connection according to claim 11, wherein the intermediate space is configured as a capillary solder gap.

13. The connection according to claim 12, wherein the mixed-phase region has a thickness which corresponds to the capillary solder gap width of the capillary solder gap.

14. The connection according to claim 11, wherein the metal part comprises titanium, hafnium, zirconium or an alloy of these elements.

15. The connection according to claim 11, wherein the mixed-phase region is formed by a silver- or gold-based solder and the portion of dissolved metal part.

16. The connection according to claim 11, wherein during the soldering process, a thickness of the metal part of at least 3 μm normal to the surface of the metal part 2, 3, which faces the intermediate space or the capillary solder gap, is completely dissolved and fills the intermediate space together with the solder.

17. The connection according to claim 11, configured as a ceramic duct, which enables the electrically and/or thermally insulated passage of a conductor through a housing.

18. The connection according to claim 17, wherein the ceramic duct is disposed in a housing, wherein the ceramic duct encases a conductor connected to a measuring element.

19. A high-temperature sensor comprising a ceramic duct according to claim 18.
